(19) United States
(12) Patent Application Publication
(10) Pub. No.: US 2013/0167028 A1
(43) Pub. Date: Jun. 27, 2013

(54) RESTRICTING MEDIA CONTENT RENDERING

(71) Applicants: Oliver Goldman, Los Altos, CA (US); Michelle Sintov, San Francisco, CA (US); Christopher Peterson, Oakland, CA (US); Emmy Huang, San Francisco, CA (US); Tinic Uro, San Francisco, CA (US); Thibault Imbert, San Francisco, CA (US)

(72) Inventors: Oliver Goldman, Los Altos, CA (US); Michelle Sintov, San Francisco, CA (US); Christopher Peterson, Oakland, CA (US); Emmy Huang, San Francisco, CA (US); Tinic Uro, San Francisco, CA (US); Thibault Imbert, San Francisco, CA (US)

(73) Assignee: ADOBE SYSTEMS INCORPORATED, San Jose, CA (US)

(21) Appl. No.: 13/174,572

(22) Filed: Jun. 30, 2011

Related U.S. Application Data
(60) Provisional application No. 61/492,317, filed on Jun. 1, 2011.

(51) Int. Cl. G06F 3/048; G06F 13/14; G06F 15/16

(52) U.S. Cl. 715/716; 709/203; 345/520

(57) ABSTRACT

Methods, systems, and apparatus, including computer programs encoded on a computer storage medium, for restricting media content rendering. In one aspect, a method includes loading different media content elements, rendering the different media content elements in a graphical user interface, and restricting rendering of at least one of the different media content elements based on presence of media content of a predefined type.

### CROSS REFERENCE TO RELATED APPLICATIONS

This application claims the benefit of priority from U.S. Provisional Application entitled “RESTRICTING MEDIA CONTENT RENDERING”, filed Jun. 1, 2011, and assigned Application Serial No. 61/492,317.

### BACKGROUND

This specification relates to programs that are run in conjunction with media content rendering.

The Internet is widely used to distribute media content, including video, graphic, audio, and scripting data. In addition, media content can include associated metadata that provides information about the content to be rendered such as author, publication and licensing information. Moreover, metadata (or an associated script) can also include a recommended frame rate for media playback. Media content can be downloaded as a file, or streamed to a client computer, where a media player application can process and output (i.e., render) the media content to a display device and, if applicable, one or more speakers. The media player application or an application including media player functionality, in some examples, can be a program written for a particular operating system (OS) on a computer platform or “plug-in” based software that runs inside another program, such as a runtime environment, on a computer platform.

Media content developed within a scripting language includes at least a scripting portion and a graphic portion, as well as other optional data portions such as audio. For each frame of frame-based media content developed within a scripting language, for example, processing time can be devoted to first interpreting the scripting data and then rendering the graphic (e.g., video, animation, still image, etc.) data. Examples of scripting languages include ACTIONSCRIPT™ by Adobe Systems Incorporated of San Jose, CA, JAVA™ by Sun

Microsystems Incorporated of Santa Clara, Calif., PYTHON® by Python Software Foundation (PSF), and Ruby by Yukihiro Matsumoto.

The rate at which media content is presented upon a user device can depend upon a number of factors, including timing information received within an audio track, a developer suggested frame rate, or a device refresh rate. In many cases, the actual frame rate can depend upon the processing rate of the user device or the current processor load. If the processor is too slow, or the processor has too many applications vying for processing time at once, the frame rate of particular media content rendered upon the user device can slow to a frame rate which is too slow for the user to properly experience. For example, the media content can appear to be stalled or choppy.

### SUMMARY

This specification describes technologies relating to programs that are run in conjunction with media content rendering and techniques for restricting media content rendering.

In general, one innovative aspect of the subject matter described in this specification can be embodied in methods that include the actions of: loading and rendering different media content elements in a graphical user interface of a computing device using a media player program; determining that at least one of the different media content elements includes media content of a predefined type; assessing a frame rate associated with the media content of the predefined type; and restricting rendering of the media content of the predefined type, if the assessed frame rate exceeds a specified maximum frame rate, and allowing rendering of the media content of the predefined type in accordance with the assessed frame rate, if the assessed frame rate does not exceed the specified maximum frame rate. Other embodiments of this aspect include corresponding systems, apparatus, and computer programs, configured to perform the actions of the methods, encoded on computer storage devices.

These and other embodiments can each optionally include one or more of the following features. The predefined type can include advertising content, and allowing rendering of the media content of the predefined type can include: allowing rendering of the media content of the predefined type in accordance with the assessed frame rate; and pausing the rendering of the media content of the predefined type in accordance with the assessed frame rate once the specified period of time has elapsed. The method can include: sending an event to provide notification of restricted or paused operation of the rendering of the media content of the predefined type.

The graphical user interface can be associated with an additional program configured to render additional content, different than the media content elements, to the graphical user interface, and the method can include: checking whether the media content of the predefined type has an associated priority that overrides restriction; checking whether a mode has been set to prevent restriction override; and restricting rendering of the media content of the predefined type when the media content of the predefined type has the associated priority that overrides restriction and the mode has been set to prevent restriction override. The method can include: receiving a message from a server to modify resource management; and changing the restricting based on the message from the server to modify resource management. The method can include: receiving user input to modify resource management; and changing the restricting based on the user input to modify resource management.

In general, one innovative aspect of the subject matter described in this specification can be embodied in a computer storage medium encoded with a computer program, the program including instructions that when executed by data processing apparatus cause the data processing apparatus to perform operations including: loading and rendering different media content elements in a graphical user interface of a computing device using a media player program; determining that at least one of the different media content elements includes media content of a predefined type; placing a restriction on rendering of the at least one of the different media content elements that includes the media content of the predefined type; and sending an event to the at least one of the different media content elements that includes the media content of the predefined type to inform the at least one media content element of, and allow response to, the restriction. Other embodiments of this aspect include corresponding systems, apparatus, and methods.

These and other embodiments can each optionally include one or more of the following features. The operations can include assessing a frame rate associated with the media content of the predefined type, and placing the restriction can include: restricting rendering of the media content of the predefined type, if the assessed frame rate exceeds a specified maximum frame rate; and allowing rendering of the media content of the predefined type in accordance with the assessed frame rate, if the assessed frame rate does not exceed the specified maximum frame rate. The predefined type can include advertising content, and allowing rendering of the media content of the predefined type can include: allowing rendering of the media content of the predefined type in accordance with the assessed frame rate; and pausing the rendering of the media content of the predefined type in accordance with the assessed frame rate once the specified period of time has elapsed.

The graphical user interface can be associated with an additional program configured to render additional content, different than the media content elements, to the graphical user interface, and the operations can include: checking whether the media content of the predefined type has an associated priority that overrides restriction; checking whether a mode has been set to prevent restriction override; and restricting rendering of the media content of the predefined type when the media content of the predefined type has the associated priority that overrides restriction and the mode has been set to prevent restriction override. The operations can include: receiving a message from a server to modify resource management; and changing the restriction based on the message from the server to modify resource management. The operations can include: receiving user input to modify resource management; and changing the restriction based on the user input to modify resource management.

In general, one innovative aspect of the subject matter described in this specification can be embodied in a system including: an interface to a communication network; a processor; and means for causing the processor to load different media content elements using the interface to the communication network and render the different media content elements in a graphical user interface, including means for restricting rendering of at least one of the different media content elements based on presence of media content of a predefined type and based on a hierarchy of rules specified by different entities. The rules of the hierarchy can be specified by both a provider of the at least one of the different media content elements and an end user. The means for causing can include means for informing the at least one of the different media content elements of a restriction imposed.

The means for restricting rendering can include means for bifurcating restriction based on a specified maximum frame rate for the media content of the predefined type. The means for restricting rendering can include means for comparing priority information, which is associated with the at least one of the different media content elements to override restriction, against a mode setting corresponding to restriction override. The means for restricting rendering can include means for dynamically sending and receiving messages from a server to update the hierarchy of rules. In addition, the interface can include a network interface card, and the means for causing can include a memory device integrated onto a circuit board along with the processor and the interface to the communication network.

Particular embodiments of the subject matter described in this specification can be implemented so as to realize one or more of the following advantages. The processing, battery and memory impact of one or more specific classes of media content (e.g., advertisements) can be reduced by exerting control over the frame rate and run time of such media content. This can be of particular benefit on mobile devices, such as smart phones and tablet computers. Media content that plays back at an unreasonably high frame rate, that loops endlessly and unnecessarily, or both, can be prevented from consuming more processing time and battery power than necessary. A media player program can actively manage and limit the resources that such pieces of content are allowed to consume, regardless of what they request. This can be accomplished within the context of the SWF execution model, which can make it easy for developers to predict, understand, and work within the parameters set.

Moreover, by becoming aware of what content is and is not an ad, policies specific to ad content can be enforced, and such policies can be updated dynamically. This can improve the end user's experience since ads are often considered irrelevant to the content the user wants to experience and can cause users to feel like they have lost control over their experience, and may also be poorly written causing excessive resource usage on the end users machine which degrades their experience of the primary content. In some cases, the described systems and techniques may be the only way that primary content running on a resource constrained device can run with an acceptable user experience since mixing secondary and primary content can create a situation where no content runs with an acceptable visual quality and responsiveness. In addition, by pausing ads after a certain period of time, this can save money on mobile data usage fees that might otherwise be increased by network activity performed by ad content.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram showing an example of a system in which media content rendering is restricted.

FIG. 2 shows a user interface before and after rendering is restricted.

FIG. 3 is a flowchart showing an example of a process of restricting media content rendering.

FIG. 4 is a flowchart showing an example of a process of checking a hierarchy of control for restricting media content rendering.

Like reference numbers and designations in the various drawings indicate like elements.

### DETAILED DESCRIPTION

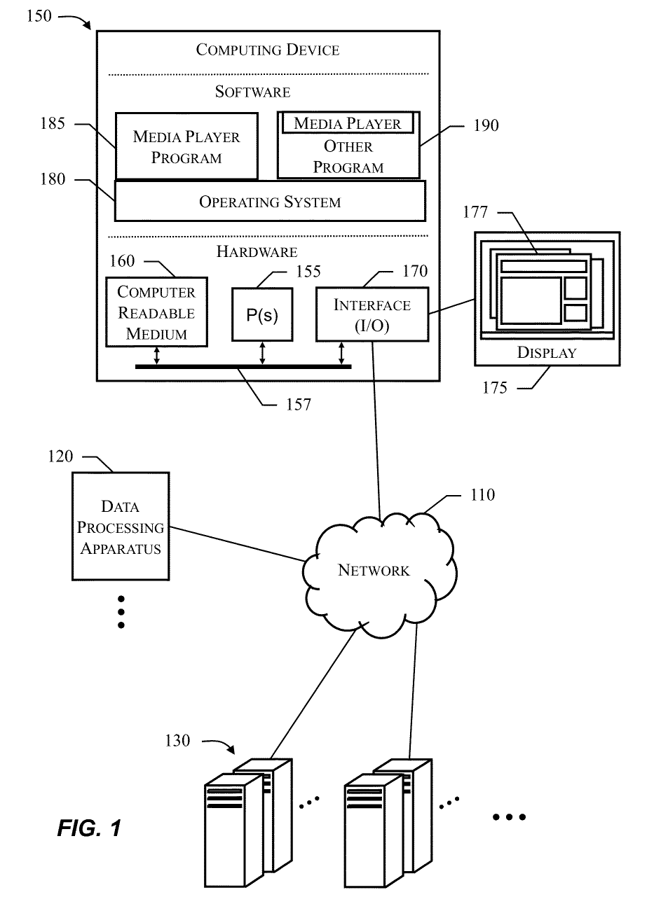

FIG. 1 is a block diagram showing an example of a system in which media content rendering is restricted. A communication network 110 provides a mechanism by which multiple different computing systems can communicate with each other. The network 110 can include local area networks (e.g., an Ethernet network), wide area networks (e.g., a campus or city computer network), public or private networks (e.g., an enterprise network), wired or wireless networks (e.g., a mobile phone network), inter-networks (e.g., the Internet), virtual private networks (VPNs), or a combination of these.

One or more data processing apparatus 120 are communicatively coupled with the network 110. These data processing apparatus 120 can include various types of computers and computing devices, such as desktop computers, laptops, tablet computers, smart phones, etc. Moreover, in some implementations, these data processing apparatus 120 can include entirely different computing platforms, with different hardware, instruction set architectures, and operating systems.

As a further detailed example, a data processing apparatus 120 can include a computing device 150, which includes hardware and software. The hardware includes an interface 170, a processing device 155, a computer-readable medium 160, and a system bus 157 to connect them, all of which can, in some implementations be integrated on a single circuit board. The system bus 157 can include multiple different types of busses, such as parallel or serial busses. The computer-readable medium 160 can include one or more non-volatile memories and storage devices (e.g., flash memory and a hard disk), one or more volatile memory devices (e.g., dynamic or static random access memory), or a combination of these.

The processing device 155 can include one or more microprocessors and/or multicore processors. The interface 170 can include different types of interface circuitry and devices, such as a network card, or a radio frequency (RF) section and antenna, to connect to the network 110. The interface 170 can also include other types of interface devices such as input/output (I/O) devices used to connect with other components, such as a keyboard, a cursor moving device, speaker(s), a microphone, a digital camera, and a display device 175. Note that one or more or all of these other components can be integrated with the computing device 150 (e.g., in the case of a smart phone, the display 175 and the computing device 150 are integrated into a single consumer electronic device). Likewise, one or more or all of these other components can be kept separate from the computing device 150 (e.g., in the case of a desktop computer, the display 175 and the computing device 150 are separately sold consumer electronic devices).

Computing systems 130 are also communicatively coupled with the network 110 and include hardware and software. While such computing systems 130 are separate from the data processing apparatus 120 and the computing device 150, their hardware can include hardware similar to one or more of the hardware devices described above for the computing device 150, and at a minimum includes at least one processor, at least one memory device, and at least one network interface, for each of one or more computing systems 130. In some implementations, a computing system 130 includes multiple server computers including multiple processors and memory devices. For example, a computing system 130 can include a server cluster or server farm, where the server computers can be located in the same general location (e.g., a specific building) or can be distributed across a wide area (e.g., across the United States and connected by the Internet).

A computing system 130 provides media content that can be rendered by a media player program 185 to a graphical user interface 177 on the display device 175. The media player program 185 can run on an operating system (OS) 180 of the computing device 150. Alternatively, the media player program 185 can be integrated into the operating system 180 or into the hardware itself (e.g., in the form of firmware code in the computing device 150).

The media content can include audio, video, graphical, and/or textual data. In some implementations, the media content can also include some form of instructions that can be interpreted, executed or both, at the receiving computing device 150. For example, the media content can include scripting data (corresponding to a scripting language) that defines and creates the user interface 177 on the display device 175 when rendered. The media content can include different types of encoded instructions and data. In some implementations, the media player program 185 can be a programmatic execution environment (or another program that uses a programmatic execution environment to run on the OS 180), and the media content can include well-defined virtual instructions or bytecode, which is interpretable by the programmatic execution environment.

The programmatic execution environment provides access to functions provided by the OS 180, and the programmatic execution environment can employ one or more isolation environments or sandboxes, where content or code that has been loaded using an isolation environment has its access to resources (e.g., network, disk or input output devices) restricted in some fashion (with varying degrees of granularity) and is prevented from accessing, modifying or interfering with code that has not been loaded into the same isolation environment (e.g., code loaded using a different isolation environment). The programmatic execution environment can be a cross-OS runtime environment that runs platform-independent bytecode. For example, the media content can include SWF content, and the programmatic execution environment can be the Adobe® Integrated Runtime (AIR™) environment, or the Adobe® Flash® Player runtime environment, both provided by Adobe Systems Incorporated of San Jose, Calif.

Such media player programs (including any programmatic execution environment) can also be run as plug-ins to another program 190, such as a web browser program. Such other programs can be configured to render additional content, different than the media content, to the graphical user interface 177. For example, in some implementations, the program 190 can be a browser program that renders HyperText Markup Language (HTML) content and includes a media player program that renders SWF content, all to the same user interface 177. Moreover, as will be appreciated, the received media content can include multiple media content elements, which can come from the same computing system 130 or from multiple different computing systems 130 (e.g., a single web page can pull media content elements from many different sites on the Web).

Rules that control resource management within the system can include definitions of which media content to which the rules apply, where such definitions can include heuristics to identify the specific type(s) of media content to restrict. There can be more than one type or class of media content, each of which can have separate and distinct restrictions applied. The same type or class of media content can also have different rules applied depending on sub-aspects of each specific content item in the class (e.g., having a requested frame rate that is higher than a specified maximum frame rate). The rules can also specify the actions to take (e.g., capped frame rate and execution time limit), where such actions can be individually enabled/disabled, or tuned (e.g., a different frame rate cap).

The rules can be configured by the end user, the content provider, the provider of the media player program (e.g., the provider of the underlying programmatic execution environment), or a combination of these. In some implementations, a “kill switch” can be provided that allows the provider of the media player program (e.g., the provider of the underlying programmatic execution environment) to turn off all resource management, as described in this disclosure. In addition, tools can be provided or enhanced to implement the rules, thus providing developers with input on whether or not their particular media content, when executed, will trigger the restrictions. Moreover, a hierarchy can be defined as to which rules take precedence. In some implementations, the user's rules take precedence over the content provider's rules, which in turn take precedence over the media player provider's rules. Other implementations are also possible.

As used herein, the predefined “type” of media content refers to a class of content generally, and need not be specific to a particular data format. The predefined type of media content can be advertising content or other types of content. For example, in some implementations, video content can be prioritized over animation content, or sound can be prioritized over video, etc. In addition, the restriction imposed can depend in part on global knowledge of all the content being rendered to the user interface or the screen overall. For example, if there is lots of ad content, then the rules may specify a different policy to apply than if there was just one ad. Likewise, when there are both ads and non-ad content, then the rules may specify different policies based on the amount of ad and non-ad content. Thus, the rules can specify different global policy decisions based on all the content being displayed (e.g., all the content on a given web page).

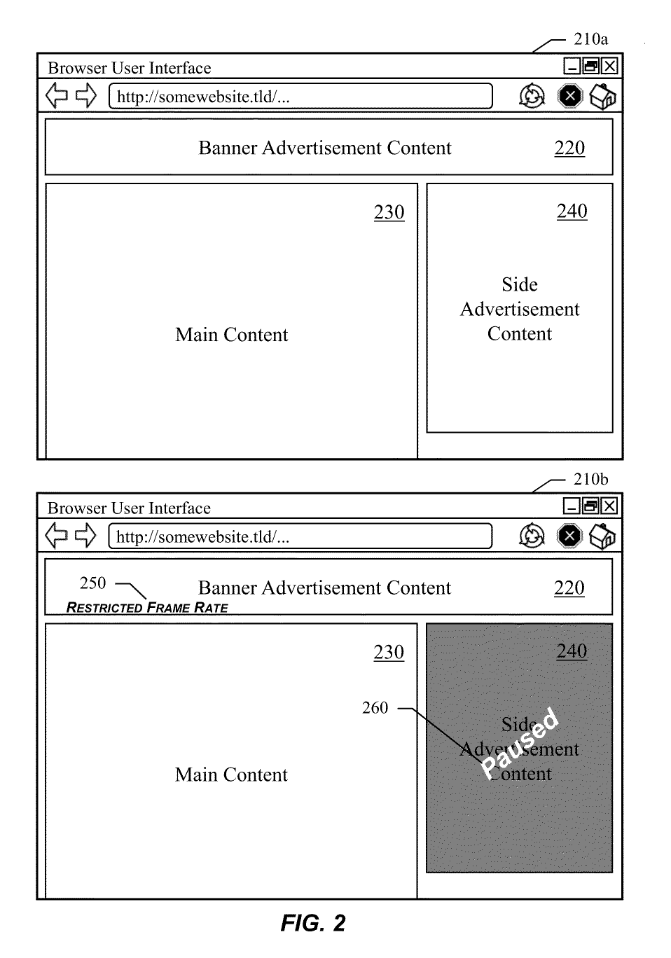

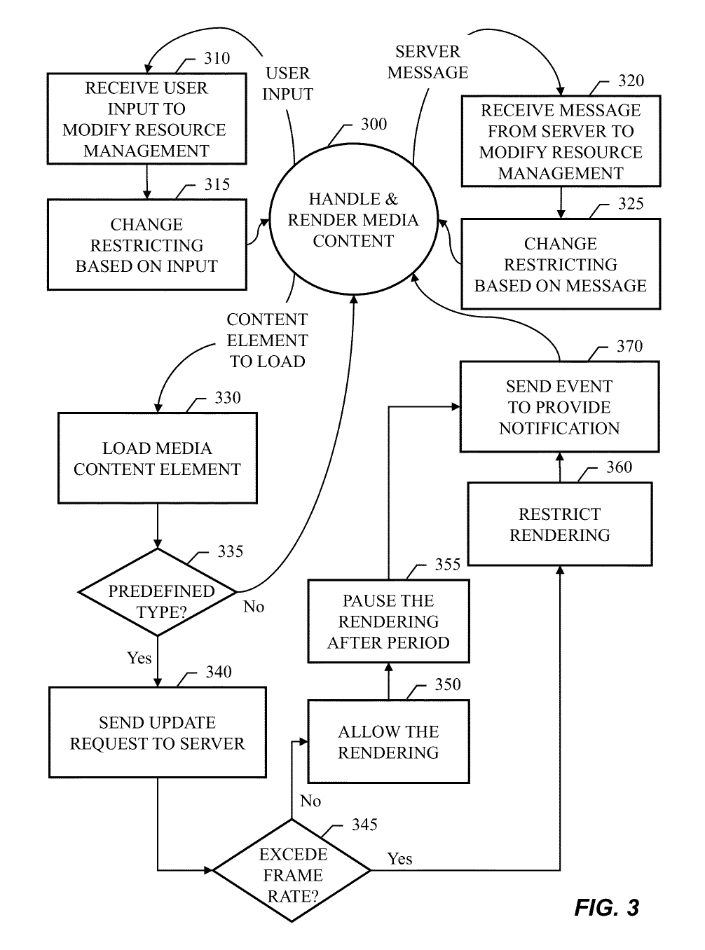

FIG. 2 shows a user interface 210a, 210b before and after rendering is restricted. The user interface 210a includes banner advertisement content 220, main content 230 and side advertisement content 240. After restrictions have been imposed, such as described further below in connection with FIG. 3, the user interface 210b includes a notification 250 of a restricted frame rate applied to the banner advertisement content 220, and a notification 260 that the side advertisement content 240 has been paused. In some implementations, restricted content (e.g., paused or suspended content) can be restarted by the user, e.g., by clicking on the content in the user interface. For example, in the paused state, any active hotspots or links presented by the rendered (but paused) content can still be active, and any click by a user on the paused content outside of an active hotspot or link can cause playback to resume. In some cases, an additional user interface can be displayed over the restricted content to indicate that it can be restarted, as well as to inform the user as to why it was restricted in the first place. In some implementations, such overlay user interfaces should take into account the fact that some display colors take more power than others (e.g., white pixels take more power than black pixels in some types of display devices).

FIG. 3 is a flowchart showing an example of a process of restricting media content rendering. User input can be received 310 to modify resource management. This can involve receiving user input through a media player program management user interface that the user opens on her own initiative, or through a media player program management user interface that is opened automatically in the course of operating the media player program. Thus, the user input can occur outside of the rendering operations of the media player program or in the course of handling media content for display (as shown).

The user input can specify rules to govern when and how to restrict media player content rendering, which can include rules governing when to impose frame rate caps and when to suspend or pause media content rendering. In some implementations, after changing 315 the restricting based on the user input, the process returns to a main processing state 300, where media content is handled and rendered. The management user interface can be designed to provide a simple set of controls that allows the user to indicate priorities for content management (e.g., prioritize battery life over content playback/functionality). For example the management user interface can include three options, as follows: (1) Optimize for battery, where all ads are restricted on start-up (e.g., suspended); (2) Balanced, which can be the default setting on mobile computers, where non-conforming ads (e.g., those that exceed a specified maximum frame rate) are restricted; and (3) Optimize content playback, which can be the default setting on desktop computers, where all content is played without restriction in accordance with the techniques described herein (although other restrictions may be imposed by other sources).

A message can be received 320 from a server (e.g., a server computer system 130 in FIG. 1) to modify resource management. The message can be sent upon the server's initiation or in response to a request from the media player program. The server message can specify rules to govern when and how to restrict media player content rendering, which can include rules governing when to impose frame rate caps and when to suspend or pause media content rendering. Any conflicts between the rules specified by the server and the rules specified by the user can be resolved in favor of the user's rules, or the user can be prompted to see whether one or more server rules should take precedence over one or more user rules. In some implementations, after changing 325 the restricting based on the server message, the process returns to the main processing state 300, where media content is handled and rendered.

Each media content element can be loaded 330, using an isolation environment, before being rendered 300 in a graphical user interface. For each loaded media content element, a check can be made 335 to determine whether it includes media content of a predefined type. For example, the predefined type can be advertising content, and the content can be identified as being an ad based on a click tag (which is used to track clicks on content) being present (e.g., doing a case-insensitive search of an entire Universal Resource Locator (URL) string for a clickTAG parameter), based on dimensions of the content (e.g., banner ads typically have a pixel area of 468×60 pixels), based on the network domain from which the content came (e.g., a commonly known ad server), or a combination of these. If the media content element does not include media content of the predefined type, it can be rendered 300 as normal. However, if the media content element does include media content of the predefined type, then further processing operations can be performed. These processing operations can include those described below, as well as other operations, such as checking if the content of the predefined type will not be visible when rendered (e.g., it will be off screen or behind something else), and in such case, not running the content at all.

In some implementations, an update request can be sent 340 to a server to obtain any recent changes in the rules governing when and how to restrict media player content rendering. In some implementations, the process can then wait for a response before proceeding. In other implementations, the update request can trigger the server message discussed above. Moreover, in some implementations, the update request may be sent 340 only if a specified period has elapsed (e.g., one day) since a most recently sent prior update request, or the update request can be made periodically, entirely outside of the process of checking specific media content elements to be rendered, or the update request can be made before a modification is made to resource management. Thus, the server can be checked dynamically for updates in various manners. Moreover, such updates can modify the rules, policies, hierarchy and/or heuristics for an already installed media player program, without having to release an updated version of the media player program (or the underlying programmatic execution environment on which it is built).

A check can be made to assess 345 whether a frame rate associated with the media content of the predefined type exceeds another associated frame rate. For example, the media content of the predefined type may have a requested or target frame rate that exceeds a maximum frame rate specified for that predefined type of media content. In the context of ad content, the specified maximum frame rate can be eighteen frames per second. Other maximum frames rates can be used in various implementations, with the typical goal being to provide energy savings where possible. This can be the default maximum frame rate, which can then later be changed by the user, the server, or both.

If the frame rate is exceeded for the media content of the predefined type, a restriction can be placed 360 on the rendering of this media content. This restricting can include capping the frame rate of the media content at the specified maximum frame rate, or a different (configurable) rate, or suspending the rendering of the media content all together (e.g., paused upon start-up). Other types of restrictions are also possible. For example, resources such as memory, number of network requests, etc. can also be constrained. In some implementations, paused content can be entirely prevented from executing script or changing the display (except if network traffic comes in), whereas throttled content can execute script and change the display, albeit slowly. Moreover, the various types of restrictions can be defined by the user, the server, or both.

If the frame rate is not exceeded for the media content of the predefined type, the rendering of the media content can be allowed 350. This can involve rendering the media content at its requested or target frame rate for at least a period of time before imposing a restriction. For example, the rendering can be paused 355 after the media content is rendered for a period of time (e.g., thirty seconds, or another time period, with the typical goal being to provide energy savings where possible). This period can be set according to the passage of actual time, i.e., wall-clock execution time, rather than total processing unit execution time. Other types of permissive rendering are also possible. For example, in some implementations, if the user interacts with the media content during the period of time that it is rendered, this can be considered to indicate the content is important to the user, and the pausing can then be avoided. In addition, the various types of allowing and restricting can be defined by the user, the server, or both. Moreover, the individual media content items can each provide a static (“poster”) image to be displayed when it is paused or suspended, as well as possibly for other reasons.

In any case, the media content of the predefined type can be handled separately from other content, and the media content of the predefined type can have at least two distinct processing path definitions depending on a frame rate associated therewith. Moreover, in some implementations, whenever a permissive rendering or rendering restriction is effected, an event can be sent 370 to provide notification thereof. The event can be dispatched to the media content itself (e.g., through an Application Program Interface (API) provided to interface the media content with the media player program), which the media content can use to generate a notification or for other purposes (e.g., logging of restrictions taken, or some action that gracefully handles the situation with that content for the end user).

The notifications can be provided to a user of the data processing apparatus, to the server that modifies resource management rules, to the media content provider, or some combination of these. The notification (e.g., such as that given to a user, as shown in FIG. 2) can be used to activate a message display (e.g., “Content paused to save energy. Click to resume.” can be displayed on a mouse over event) and can include a link to manage resource management settings. Moreover, the event dispatch upon restriction can be used in other implementations, which need not include the two distinct processing paths for media content of the same predefined type.

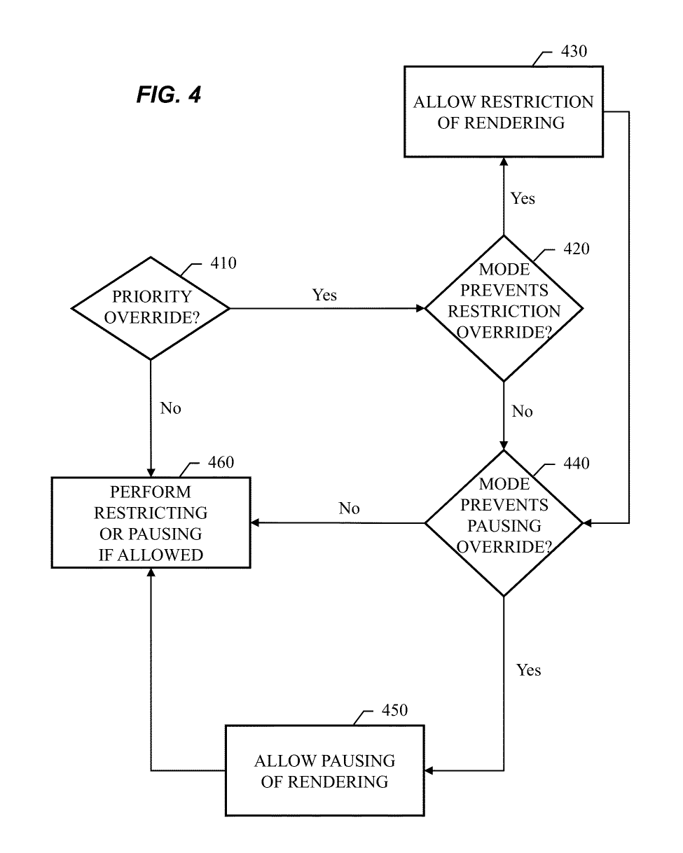

FIG. 4 is a flowchart showing an example of a process of checking a hierarchy of control for restricting media content rendering. A check can be made 410 to determine whether media content of the predefined type has an associated priority that overrides restriction. For example, a specific media content item (e.g., a specific ad) can have associated priority information, either included in the content or provided separately by a server of the content or a server of the resource management rules, where the priority information indicates that this specific media content item should not be subject to the same restriction as other content of the same type.

If the associated priority information is present, a check can be made 420 to determine whether a mode of operation has been set (e.g., by a user) to prevent restriction override. This mode of operation can be of the media player program itself, or a mode associated with an additional program, such as a web browser in which the media player program runs. If the mode has been set, then restriction of the rendering is allowed 430 for the media content, even though the associated priority information indicates the restriction should be overridden.

The mode can apply to any and all restrictions on rendering, or the mode can include multi-part mode information that corresponds to different types of rendering restrictions that can be performed. Thus, in some implementations, a check can be made 440 to determine whether the mode of operation has been set to prevent pausing override. If the mode has been set for this, then pausing of the rendering is allowed 450 for the media content, even though the associated priority information indicates the pausing should be overridden.

Restricting or pausing are then performed 460, if allowed. Thus, providers of media content can indicate a desire to opt-out of the rendering restriction scheme, but such desire can be considered secondary to the user's instructions. For example, in some implementations, the priority information associated with an ad can cause override of the restriction when the current mode is set to “Balanced”, but when the current mode is set to “Optimize for battery”, that same priority information can be disregarded in favor of the user's preference to conserve battery power.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results.

What is claimed is:

1. A method performed by data processing apparatus, the method comprising:
loading and rendering different media content elements in a graphical user interface of a computing device using a media player program;
determining that at least one of the different media content elements includes media content of a predefined type;
assessing a frame rate associated with the media content of the predefined type; and
restricting rendering of the media content of the predefined type, if the assessed frame rate exceeds a specified maximum frame rate, and
allowing rendering of the media content of the predefined type in accordance with the assessed frame rate, if the assessed frame rate does not exceed the specified maximum frame rate.

2. The method of claim 1, wherein the predefined type is advertising content, and allowing rendering of the media content of the predefined type comprises:
allowing rendering of the media content of the predefined type in accordance with the assessed frame rate; and
pausing the rendering of the media content of the predefined type in accordance with the assessed frame rate once the specified period of time has elapsed.

3. The method of claim 1, comprising:
sending an event to provide notification of restricted or paused operation of the rendering of the media content of the predefined type.

4. The method of claim 1, wherein the graphical user interface is associated with an additional program configured to render additional content, different than the media content elements, to the graphical user interface, the method further comprising:
checking whether the media content of the predefined type has an associated priority that overrides restriction;
checking whether a mode has been set to prevent restriction override; and
restricting rendering of the media content of the predefined type when the media content of the predefined type has the associated priority that overrides restriction and the mode has been set to prevent restriction override.

5. The method of claim 1, comprising:
receiving a message from a server to modify resource management; and
changing the restricting based on the message from the server to modify resource management.

6. The method of claim 1, comprising:
receiving user input to modify resource management; and
changing the restricting based on the user input to modify resource management.

7. A computer storage medium encoded with a computer program, the program comprising instructions that when executed by data processing apparatus cause the data processing apparatus to perform operations comprising:
loading and rendering different media content elements in a graphical user interface of a computing device using a media player program;
determining that at least one of the different media content elements includes media content of a predefined type;
placing a restriction on rendering of the at least one of the different media content elements that includes the media content of the predefined type; and
sending an event to the at least one of the different media content elements that includes the media content of the predefined type to inform the at least one media content element of, and allow response to, the restriction.

8. The computer storage medium of claim 7, wherein the operations comprise assessing a frame rate associated with the media content of the predefined type, and placing the restriction comprises:
restricting rendering of the media content of the predefined type, if the assessed frame rate exceeds a specified maximum frame rate; and
allowing rendering of the media content of the predefined type in accordance with the assessed frame rate, if the assessed frame rate does not exceed the specified maximum frame rate.

9. The computer storage medium of claim 8, wherein the predefined type is advertising content, and allowing rendering of the media content of the predefined type comprises:
allowing rendering of the media content of the predefined type in accordance with the assessed frame rate; and
pausing the rendering of the media content of the predefined type in accordance with the assessed frame rate once the specified period of time has elapsed.

10. The computer storage medium of claim 7, wherein the graphical user interface is associated with an additional program configured to render additional content, different than the media content elements, to the graphical user interface, and the operations comprise:
checking whether the media content of the predefined type has an associated priority that overrides restriction;
checking whether a mode has been set to prevent restriction override; and
restricting rendering of the media content of the predefined type when the media content of the predefined type has the associated priority that overrides restriction and the mode has been set to prevent restriction override.

11. The computer storage medium of claim 7, wherein the operations comprise:
receiving a message from a server to modify resource management; and
changing the restriction based on the message from the server to modify resource management.

12. The computer storage medium of claim 7, wherein the operations comprise:
receiving user input to modify resource management; and
changing the restriction based on the user input to modify resource management.

13. A system comprising:
an interface to a communication network;
a processor; and
means for causing the processor to load different media content elements using the interface to the communication network and render the different media content elements in a graphical user interface, including means for restricting rendering of at least one of the different media content elements based on presence of media content of a predefined type and based on a hierarchy of rules specified by different entities.

14. The system of claim 13, where the rules of the hierarchy are specified by both a provider of the at least one of the different media content elements and an end user.

15. The system of claim 13, wherein the means for causing includes means for informing the at least one of the different media content elements of a restriction imposed.

16. The system of claim 13, wherein the means for restricting rendering comprises means for bifurcating restriction based on a specified maximum frame rate for the media content of the predefined type.

17. The system of claim 13, wherein the means for restricting rendering comprises means for comparing priority information, which is associated with the at least one of the different media content elements to override restriction, against a mode setting corresponding to restriction override.

18. The system of claim 13, wherein the means for restricting rendering comprises means for dynamically sending and receiving messages from a server to update the hierarchy of rules.

19. The system of claim 13, wherein the interface comprises a network interface card.

20. The system of claim 13, wherein the means for causing comprises a memory device integrated onto a circuit board along with the processor and the interface to the communication network.
